(19) United States
(12) Patent Application Publication
(10) Pub. No.: US 2013/0311219 A1
(43) Pub. Date: Nov. 21, 2013

(54) CROWD-SOURCE BASED SYSTEM AND METHOD OF SUPERVISING AND DISPATCHING ON-LINE CONTENT PRODUCTION FOR ADVOCACY AND SEARCH ENGINE OPTIMIZATION

(71) Applicant: Yechezkel Zvi Green, Herzelia (IL)

(72) Inventor: Yechezkel Zvi Green, Herzelia (IL)

(21) Appl. No.: 13/279,322

(22) Filed: Oct. 23, 2011

Related U.S. Application Data
(60) Provisional application No. 61/406,339, filed on Oct. 25, 2010.

(51) Int. Cl. G06Q 10/06

(52) U.S. Cl. CPC G06Q 10/06311
USPC 705/7.14

(57) ABSTRACT

An automated system and method provide content to a target website wherein the content is checked prior to posting the content to the target site. The automation of the method relies on the use of a client software application, which carries out much of the automated functionality in association with an agent server. The method may include safeguards to prevent circumvention. Content may be written, checked and submitted from a writer's own computer to preserve the authenticity of the writings. An optional multilevel reward system encourages the expansion of the crowd-source employee base. The method enables the distribution and control of content writing tasks to a crowd of writers.

This patent application claims the benefit of U.S. Provisional Patent Application No. 61/406,339 filed 25 Oct. 2010.

### TECHNICAL PROBLEM

There is a need for a dispatching method and system to supervise (coordinate, manage, monitor, verify and audit) performance of tasks by multiple agents. Particularly there is a need to recruit, supervise, oversee, provide quality control over and compensate a crowd of content writers in order to submit a plurality of content items to a single target site, each item legitimately and verifiably authored and submitted by a distinct human agent.

### FIELD AND BACKGROUND OF THE INVENTION

Various methods and systems to provide quality content items from verifiably distinct human agents to a target site are possible, and particularly, methods and systems may oversee a crowd-sourcing campaign wherein each content item is provided to the target site directly from a computer associated with the agent author of the content item.

With nearly 14 billion online searches every month, the ranking of a website in search engines can have a significant effect on its traffic volume. The Cost per Click (CPC) for advertising is rising due to increasing competition and people are learning to ignore banner ads. Therefore, site owners have found that positioning their site through Search Engine Optimization (SEO) can be the most effective way of generating business. Some of the main factors influencing Website ranking are:

1. Volume of content change, for example by adding articles, posts and talkbacks

2. Quality and quantity of traffic to the site—quality of traffic is determined by number of visits from unique IP addresses, amount of time spent each visit and activity taken on the site

3. Quantity of links on related sites referring to the ranked site

Increasing these three factors represents a challenge for both website owners and SEO service providers. Currently web owners and SEO providers mainly use one of two strategies: automatic content addition or hiring content writers. Automatic content addition often results in a ranking penalty by search engines. Hiring content writers with relevant knowledge is often quite difficult. Therefore, advertisers seek different ways promote their sites and advocate their viewpoints.

In spite of the difficulties and costs, advertisers and other institutions, such as governments or political organizations, are constantly seeking content writers to promote products and ideas.

The lack of legitimate tools to influence the Internet has produced a power vacuum that allows extremist groups (unfettered by questions of propriety) to take control over the Internet and social networks (through violent coercion, identity theft and deceit) and harness its potential to create a social tsunami. The desperate need for tools to produce large quantities of on-line content by distinct authors is underscored by a recently revealed US Army program that is investing millions of dollars in fake identities for Internet advocacy (“Revealed US spy operation that manipulates social media,” Nick Felding and Ian Cobain, Thu., 17 Mar. 2011).

One promising method to provide authentic human content at a reduced price is using crowd-sourcing. Current applications and technical difficulties of crowd-sourcing are described by Jeff Howe in his book HOWE, Jeff. Crowdsourcing: Why the Power of the Crowd is Driving the Future of Business. 1st edition. NY: Crown Business, 2008. p. 311. While Crowd-sourcing holds promise for supplying human creativity at a reduced price, applications of crowd-sourcing to content writing, advocacy and SEO are lacking.

Furthermore, various technical problems have been identified in the logistical supervision of a crowd-sourcing campaign. This results in a few known difficulties:
added costs to bring a project to an acceptable conclusion;
increased likelihood that a crowd-sourced project will fail due to lack of monetary motivation, too few participants, lower quality of work, lack of personal interest in the project, global language barriers, or difficulty managing a large-scale, crowd-sourced project;
lack of written contracts, non-disclosure agreements, or employee agreements or agreeable terms with crowd-sourced employees;
difficulties maintaining a working relationship with crowd-sourced workers throughout the duration of a project, and
Susceptibility to faulty results caused by targeted, malicious work efforts.

Therefore it is desirable to have a method and system to provide desired content that may be used to advocate agendas on forums, social networks, forums, portals, and news sites and to raise search engines rating of a site. It would be particularly desirable to supply a high volume of content that is verifiably and legitimately the result of distinct human authors at a reduced cost to web site owners, advertisers and advocacy organizations.

### SUMMARY OF THE INVENTION

Various methods and systems to oversee and supervise production of quality content items from verifiably independent human agents to a target site are presented herein below.

According to an aspect of some embodiments of the present invention there is provided a method for dispatching content production. The method may include initiating an invitation for producing the content to a crowd of potential agents. The method may also include updating a client application for each agent that actually participates in the campaign. Each client application may be updated in order to submit a content item authored by the respective agent directly from his personal computing device to a target site. Each respective client application may also be updated with data needed to facilitate verification of a compliance of the respective content item to a campaign profile prior to the submitting.

According to some embodiments of the invention, the updating is also for notifying a central server of a status of the respective content item.

According to some embodiments of the invention, the updating includes data necessary for notifying the central server: upon completion of the respective content item by the agent, upon submission of the respective content item to the target site, upon reception of approval notification from the target site, upon unauthorized communication by the agent with the target site, or upon inactivity of the agent's respective personal computing device.

According to some embodiments of the invention, the verification of compliance may includes at making a local grammar check, making a local keyword check, making a local check for undesirable matter, sending the respective content item to the server for the verification, sending the respective content item to an unaffiliated third party for the verification, rerouting a submission to the target site, trapping a submission to the target site or sending the respective content item to a customer for the verification.

According to some embodiments of the invention, the method may further include reimbursing the agent.

According to some embodiments of the invention, the reimbursing may be dependent upon submission of the respective content item to the target site, verification of the respective content item, and posting of the respective content item by the target site.

According to some embodiments of the invention, the reimbursing may further include reimbursing a recruiting agent from the crowd of potential agents, when the recruiting agent recruited the agent author.

According to some embodiments of the invention, the method may further include receiving an order from a customer for the content and maintaining anonymity of the each agent from the customer. Furthermore, the method may include preserving anonymity of the customer from the agent.

According to some embodiments of the invention, the target site may be associated with the customer, or it may be independent of the customer, or it may be independent of the server, or it may be a blog, or a social network, or a forum, or a portal, or a talkback list.

According to an aspect of some embodiments of the present invention there is provided a system for production of content. The system may include a server configured for initiating an invitation to produce the content to a crowd of potential agents and verifying compliance of a plurality of content items each content item of the plurality of content items authored by a unique author from the crowd of potential agents. The system may also include a plurality of client applications. Each application may be configured for submitting to a target site a respective content item of the plurality of content items. The submitting may be done from a personal computing device associated with the corresponding unique author.

According to some embodiments of the invention, each of the plurality of client applications may be further configured for notifying the server of a status of the respective content item.

According to some embodiments of the invention, each of the client applications may be further configured for notifying the server of completion of the respective content item by the corresponding unique author, submission of the respective content item to the target site, or reception of an approval notification from the target site.

According to some embodiments of the invention, the client applications may be further configured for facilitating verification of compliance of the respective content item to a campaign profile prior to the submitting.

According to some embodiments of the invention, the plurality of client applications may be further configured for sending the respective content item to the server for the verification, sending the respective content item to an unaffiliated third party for the verification, or sending the respective content item to a customer for the verification.

According to some embodiments of the invention, the server may be further configured for reimbursing an agent.

According to some embodiments of the invention, the server may be configured for performing the reimbursing dependent upon submission of the respective content item to the target site, verification of the respective content item, or posting of the respective content item by the target site.

According to some embodiments of the invention, the server may be further configured for reimbursing a recruiting agent, when the recruiting potential agent recruited the unique corresponding author.

According to some embodiments of the invention, the server may be further configured for receiving an order from a customer for the content, and each client applications may be further configured for maintaining anonymity of the corresponding unique author from the customer.

According to some embodiments of the invention, the client applications may be further configured for preserving anonymity of the customer from the corresponding unique author.

According to some embodiments of the invention, the target site may be associated with the customer, or it may be independent of the customer, or it may be a blog, social network, or it may be forum, or it may be portal, or it may be independent of the server, or it may be a talkback posting system.

### TERMINOLOGY

The following terms are used in this application in accordance with their plain meaning, which is understood to be known to those of skill in the pertinent art(s). However, for the sake of further clarification in view of the subject matter of this application, the following explanations, elaborations and exemplifications are given as to how these terms may be used or applied herein. It is to be understood that the below explanations, elaborations and exemplifications are to be taken as exemplary or representative and are not to be taken as exclusive or limiting. Rather, the terms discussed below are to be construed as broadly as possible, consistent with their ordinary meanings and the below discussion.
Crowd-sourcing is the practice of obtaining needed services, ideas, or content by soliciting contributions from a large group of people and especially from the online community rather than from traditional employees or suppliers.
A content item is an article meant to convey an idea or point of view, especially in an on-line forum. Examples of content items include posts, blogs, talk-backs, comments, articles, video clips, responses and audio clips.
A client application is a program designed to perform a function on a client computer. Client applications can include plugins, extensions, proxies, macros, client software, client hardware, modules or independent programs. Client Application is installed on the agent's computer.
Updating a client application may include adding data to an existing application on a client computer, for example adding a new list of required keywords or a new target address to a database associated with a routine already installed on a client computer;
Initiating an invitation to an agent can include sending an invitation message to the agent and posting the invitation on a web site accessible to the agent.

### BRIEF DESCRIPTION OF THE DRAWINGS

Various embodiments of a system and method for filtering undesired content are herein described, by way of example only, with reference to the accompanying drawings, where:

FIG. 1 is a simple schematic overview of some aspects of a content production system for SEO;

FIG. 2 is a flowchart of a method of content production;

FIG. 3 is a simplified schematic representation of some aspects of a content production system for advocacy;

FIG. 4 is an illustration of multilevel employment.

### DESCRIPTION OF THE PREFERRED EMBODIMENTS

The principles and operation of a system and method for supervising production of content according to various embodiments may be better understood with reference to the drawings and the accompanying description. Although various example embodiments are described in considerable detail, variations and modifications thereof and other embodiments are possible. Therefore, the spirit and scope of the appended claims is not limited to the description of the embodiments contained herein.

A system is provided for directing and monitoring interactions between a crowd of paid writers and target site without the system directly interacting with the target site. Thus, the system allows a user to generate a large quantity of content that is legitimately attributed to a crowd of individuals. The content has the appearance of having been generated independently.

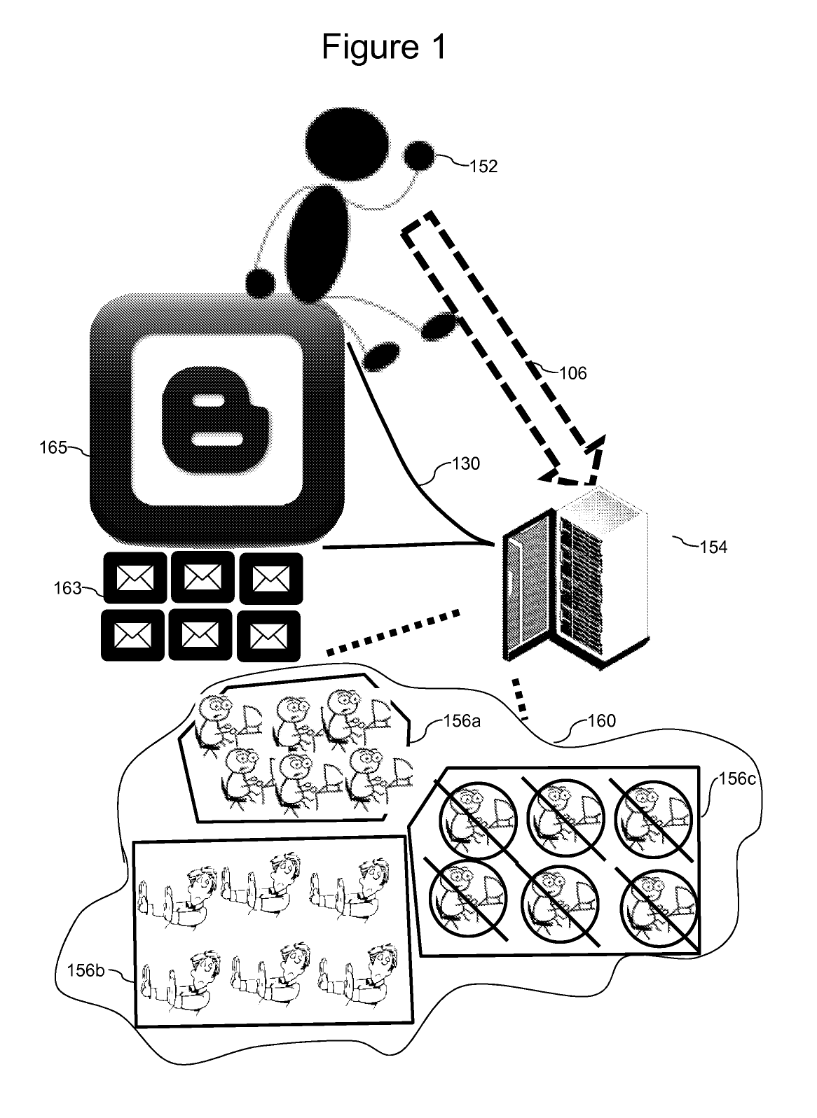

FIG. 1 provides a general overview of an automatic and autonomous web platform (a server 154) which provides a service for finding post and talkback writers to conduct a campaign to boost search engines domain rank of a target website 165 associated with a customer 152. The system makes provides customer 152 with convenient and cost effective way to produce a large quantity of content legitimately attributed to a large number of distinct human authors.

Customer 152 sends 106 an order for the campaign to system server 154 by specifying criteria desired in content authors and in content produced. Customer 152 also specifies his website 165 as a target site for posting the content and supplies money for the campaign. System server 154 supervises execution of the campaign using crowd-sourcing. Particularly, system server 154 includes a database of a large crowd 160 of potential agents 156a, 156b and 156c. An agent is a paid writer and a member of the system. Server 154 sends an invitation to join the campaign to qualified agents 156a,b fitting the author criteria of customer 152. A plurality of participating agents 156a accept the invitation and join the campaign and each participating agent 156a installs a client application onto his personal computer. Each client application is updated to oversee the writing and posting of content for the campaign by a particular agent of participating agents 156a while installed on a computer associated with the particular agent. The client applications also handle notification and verification of content between system server 154 and participating agents 156a.

In the example of FIG. 1, each participating agent uses his respective client application on his personal computer to submit his post 163 to website 165. In this way it is possible to economically achieve a large number of posts 163 by a large number of real distinct human agents 156a to target website 165. System server 154 periodically scans 130 target website 165 to see if one of posts 163 has been published. When a post 163 is published, system server 154 also manages payment to participating agents 156a. Preferentially, system server 154 utilizes RSS (really simple syndication) and WEB 2.0 technologies and formats (such as Blogger, Wordpress, etc.), and a crowd-source methodology.

Herein below examples of campaigns are described in detail for the purpose of: 1) boosting domain rank of a site in search engines, as part of SEO efforts, by posting large quantities content of high quality (defined as coming from a large number of unique authors and unique IP addresses) to a site; and 2) promoting a product or advocating a viewpoint by adding a large quantity of quality content to a strategic third party target site.

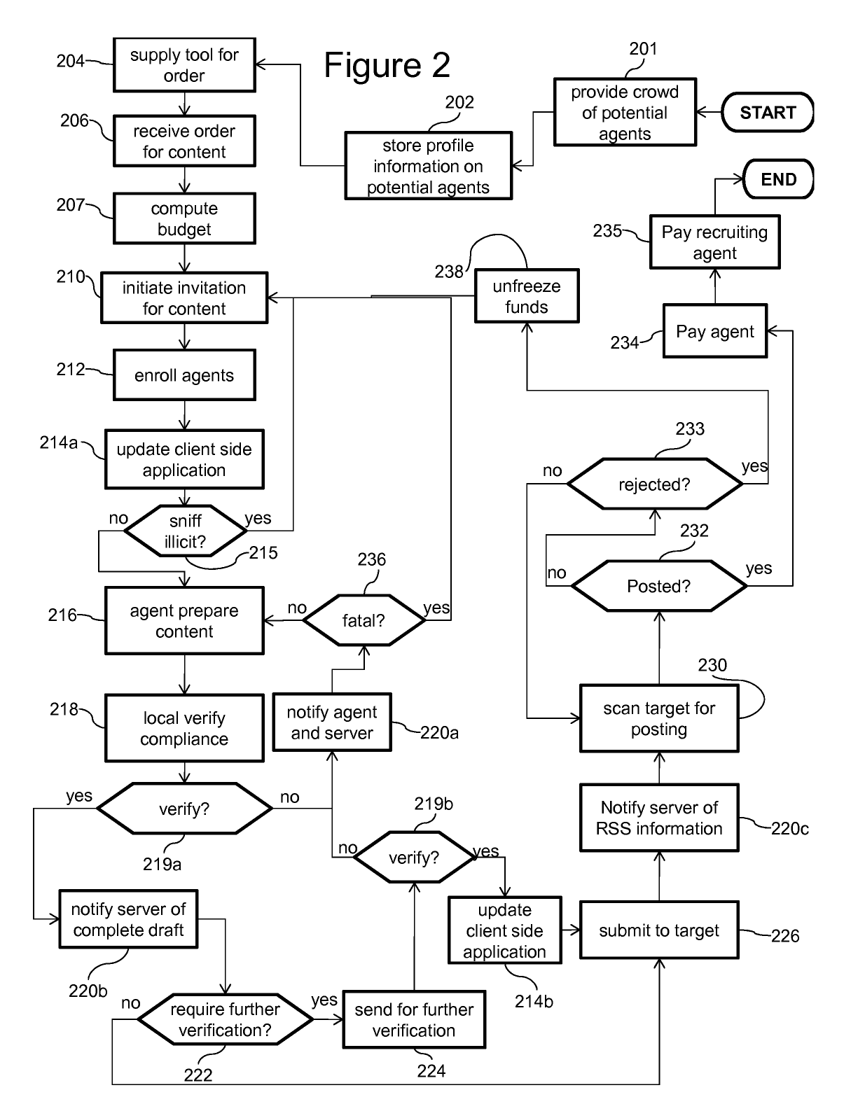

FIG. 2 is a flow chart illustration of an example of a campaign for boosting search engine ranking. Particularly in the example of FIG. 2, customer 152 is a hiking shoe manufacturer who wants to promote his blog website 165 on outdoor adventure.

System server 154 provides 201 crowd 160 of potential agents 156a,b,c for producing content such as web posts, short videos, audio tracks and talkbacks. System server 154 includes a large database in which it stores 202 information about potential agents 156a,b,c including: employment experience, education, language skills, writing experience, gender, age, hobbies, religion, political views and geographic location etc. For each potential agent 156a,b,c the database includes a track record including the number of post written, the percentage of posts verified as complying with customer objectives, the percentage of posts that are eventually approved and published by target sites and any other relevant details. This enables the customer to specify the minimal experience and track record requirements.

System server 154 receives 206 an order from customer 152 to carry out a campaign. Particularly, in the example of FIG. 2, system server 154 supplies 204 to customer 152 a tool (e.g. a web fillable form) to designate target website 165 (including web addresses, and various details about access, login and registration); the desired criteria for qualified agents 156a,b; and criteria for verifying the compliance that content items fulfill the campaign objectives.

In the example of FIG. 2, customer 152 specifies a budget for the campaign, time constraints and production goals. For example customer 152 specifies that for ten consecutive days he wants up to ten men per day who have outdoor hobbies to each submit a fifty to one hundred fifty word talkback in response to a blog on website 165 describing a hiking trip in the Appalachian Mountains. Customer 152 sends to server 154 $500 for the project. Thus, server 154 offers $5.00 per post to qualifying agents 156a,b. If the goals (ten posts per day) are not reached, then customer 152 may adjust his requirements or add more money.

Alternatively, system server 154 computes 207 a budget for the campaign. The budget is based on the number of posts 163 requested, the agent criteria requested and statistics about availability and cost of qualifying agents 156a,b (fitting the criteria) in crowd 160. For instance, according to statistics stored in the database of system server 154, about 20% of invitations are accepted. Therefore in order to produce fifty posts 163, the system will find in the database two hundred and fifty qualifying agents 156a,b and compute the average price that qualifying agents 156a,b accepted for a one hundred fifty word talk back in the past (for example $5.00) and multiply by the number of talkbacks required (50×$5.00=$250) and add a system fee (for example 50%) giving a total fee of $250×1.5=$475. The price is then sent to the customer for authorization.

Alternatively, customer 152 could specify the budget and system server 154 would accept offers that were within reason (in the example above the system would accept an offer of at least $400). Alternatively, system server 154 may reserve the right to use writers lacking in some of the characteristics requested by the customer or server 154 could suggest to customer 152 alternate conditions or budget. For example system server 154 could make a counteroffer. For example, customer 152 offers only $280. System server 154 then offers to run the campaign if customer 152 allows also women writers because statistics of crowd 160 show that women writers accept lower wages than men.

Once a campaign is ordered and funded system server 154 initiates an invitation 210 to qualifying agents 156a,b to participate in the campaign. (In the example of FIGS. 1 and 2, unqualified agents 156c do not fit the criteria stipulated by customer 152 and do not receive the invitation). The invitation will include information about pay rates, and content requirements (for example the length content desired and some idea of other requirements) according to the discretion of customer 152 and the administrators of system server 154. Initiating 210 an invitation may include sending invitations by email or through a social networking site. Alternatively, a list of campaigns links and the aforementioned specifications may be stored on central server 154 and displayed to qualifying agents 156a,b when they log into their accounts on system server 154.

Once an agent from amongst qualified agents 156a,b receives an invitation to participate in a campaign he may accept (by clicking on a link on the web page or by clicking a button in a client application on his computer which sends his acceptance to the system) or reject the invitation (either by sending a refusal message or just by not answering the invitation). In FIG. 1, agents 156b reject the invitation and do not receive further information. Agents 156a accept the invitation.

System server 154 enrolls 212 participating agents 156a until the requisite number of items (for example fifty as stated above in the example of FIGS. 1 and 2) have been assigned. Once agent 156a is enrolled 212 in a campaign, a space in the campaign is reserved for him (in the example where only ten items a day are desired once ten agents 156a are enrolled 212 no other agents 156a can enroll that day). Simultaneously, the client application sniffs 215 and tracks activity associated with target site on client's computer. If suspicious activities (like unauthorized access to target web site 165), or multiple attempts to submit unfit content, or prolonged inactivity is detected, the invitation is rescinded and the invitation is re-initiated 210 back to crowd 160.

For each participating agent 156a system server 154 updates 214a a client application to run on the agent's personal computer (the term personal computer is used here in a broad sense to include all kinds of computing devices, for example a desktop computer, a laptop, notebook, workbook, notepad, smart phone, net pad, iPod®, iPad® etc.). Updating the client application includes programming the client application with a combination of locally stored information and routines and remote links to perform various functions. The functions may include transferring to each participating agent 156a information necessary to produce content (for example the length and details about the required content); the functions may further include facilitating verification of compliance of the content with the definitions and objectives of the campaign (facilitating verification includes locally verifying 218 compliance and sending 224 the content for additional confirmation according to specifications of the campaign order), the functions may further include submitting 226 of the item and safeguarding the authenticity of the submission and functions may also include notifying 220a, 200b, 220c system server 154 of the status of the production and submission process. If the client application is removed, from an agent's computer, then the agent will not be able to participate in the campaign or receive any payment from the system until the client application is reinstalled. The various functions of the client application are described in more detail herein below.

Each participating agent 156a prepares 216 a draft content item (content preparation may be done directly through the client application with an associated or built in editor or alternatively content preparation may be done using local software). It is worth emphasizing that the agent writes an authentic post of his own words and ideas according to the criteria of the campaign.

Upon completion of a draft content item, each participating agent 156a starts local verification 218. Particularly, the client application has been updated 214a with customer specified definitions of the campaign including a required length for each content item and required for keywords in Boolean format. In the example of FIGS. 1 and 2, each talkback must include the terms ((hiking or backpacking) and ((shoes or feet) or (“Appalachian trail”)). Automatic requirements enforcement routines such as word count routines, keyword searching routines, and sympathy determining algorithms included in the client application are updated for the campaign and used for verification 218 that the content fulfills the requirements of the campaign.

If the item is not verified 219a after few attempts then the central server is notified 220a of the deficiencies, which are recorded in the agent's track record in the database of the central server 154. When the deficiencies imply gross negligence or malicious intent, then they are deemed fatal 236 and the invitation to the agent is cancelled and a new agent is sought. It should be noted that at this point the agent is not aware of the identity of customer 152 or website 165. Therefore, customer 152 has been protected by the system against malicious attacks or any associated problems. If the deficiencies are minor (and deemed not fatal 236) then the agent is notified of the deficiencies and invited to prepare 216 an improved item. Alternatively, the client may be provided with the target url and the client application may sniff 215 and track interaction of the agent with target site 165. If the interaction includes suspicious activity the client application will cancel the transaction or redirect the traffic and add a mark to the agent's record. Alternatively, system server 154 may not differentiate between fatal and non-fatal rejection and in any case, agent 156a is allowed to try again (unless other agents 156a have taken all of the available spaces in the time elapsed between the trials).

When it is verified 219a that the content item fulfills the requirements of the campaign, then central server 154 is notified 220b by the client application and a copy of the draft is sent to central server 154. In the example of FIGS. 1 and 2, all postings 163 to website 165 are dependent on verification by customer 152 who is the website owner. Inappropriate items will not be posted, and therefore there is no requirement 222 for further verification 224. Thus, the content is ready to be submitted 226 by the client application directly to web site 165.

Before submission 226, the client application checks central server 154 which loads updates and finishes updating 214b of the client application. For example, in the initial updating 214a (before the agent was ready to submit content) the target web-address may have been withheld to prevent unauthorized access (even though data loaded to the client application encrypted and protected from tampering, nevertheless, not loading information at all is more secure than loading encrypted information). Furthermore, parameters of a campaign may have changed between the time of enrollment 212 and submission 226. Submission 226 is made directly from the agent's computer without any evidence of involvement of system server 154. Customer 152 and website 165 cannot determine whether a given submission is from an agent 156a of system server 154 or an independent individual. An agent may use of multiple nicknames when publishing posts/talkbacks. All of this prevents exposure by websites where posts are published and prevents biased disapproval of paid posts—the system leaves no fingerprint. The client application notifies 220c system server 154 that a post/talkback was sent and forwards all field information (which may be extracted using RSS, Wordpress format, blog format or any other relevant format. Server 154 may also include a wizard to allow customers 152 to train the system to use the customer's own proprietary format).

When system server 154 receives from the client application, notification 220b that a draft content item has been prepared, system server 154 freezes the amount of customer funds promised to agent until the post/talkback is actually posted on web site 165.

It should be noted that the client application takes care of the various logistics of verification 219a,b and submission 226 for agent 156a. This saves agent 156a the hassle of tracking the status of his submission and getting approval. Hassle free writing makes it worthwhile for agent 156a to participate in campaigns at reasonable wages.

Central server 154 periodically scans 230 (for example with crawler technology) website 165 to determine when and whether each post 163 is actually published 232 on website 165. Server 154 can easily recognize the content item because a copy of the content item and syndication information was stored on server 154 at the time of submission 226 and notification 220a,b,c. For each post 163 that is expired or gets rejected 233, system server 154 unfreezes 238 the funds allocated to agent marks the agents record and initiates 210 another invitation to produce the needed content.

For each post, 163 that is submitted 226, when system server 154 detects that the post has been published 232, system server 154 transfers 234 allocated funds to the respective agent 156a. System server 154 notifies customer 152 of the paid posting, only after it is published. This will prevent cost issues effecting publishing decision.

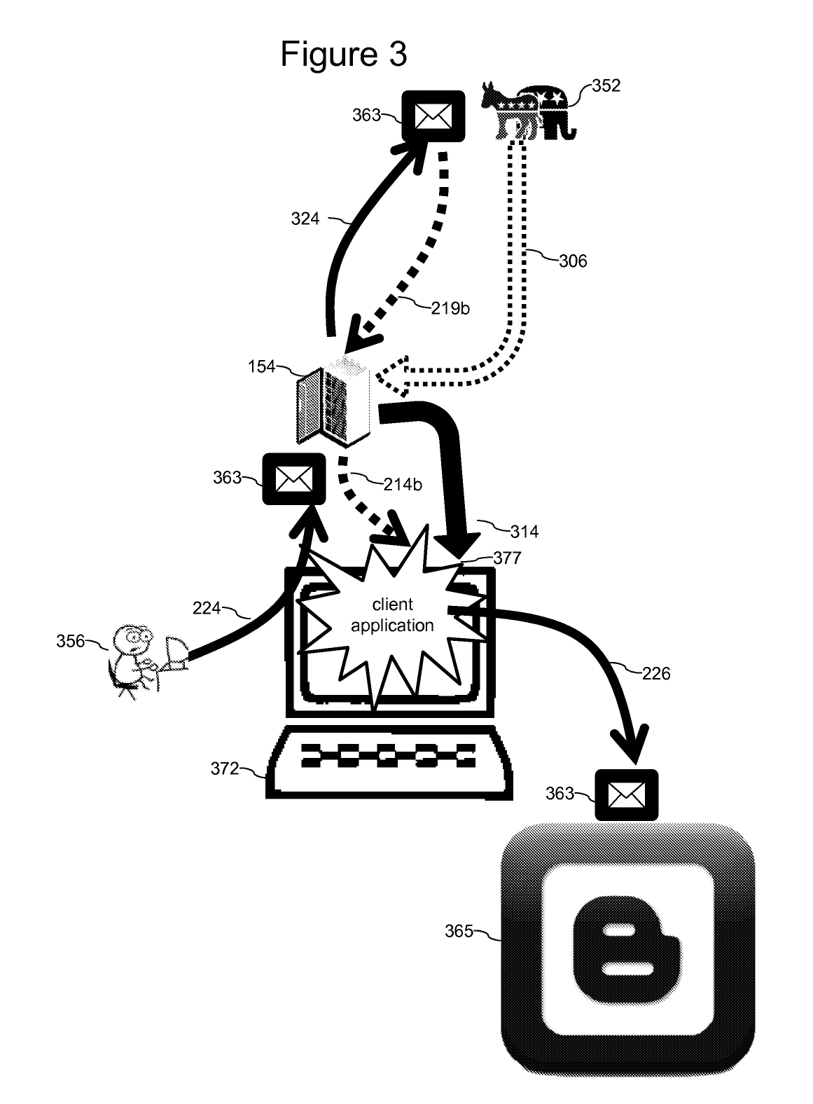

FIG. 3 is a simplified schematic illustration of a content production system for advocacy. In the example of FIG. 3, a customer 352 sends 306 an order for an advocacy campaign to system server 154. In the advocacy campaign customer 352 wants hundreds of posts to be sent to a target website 365 (a newspaper site) complaining about the poor trash collection in the Bronx. Alternatively, an advocacy campaign can be targeted for one of a multitude of different issues and the target web site could be any third party website (for example a political site, a news site, a social action web site, a Facebook® page, a political forum, a political campaign website, etc.).

System server 154 uses crowd-sourcing as illustrated above in the case of SEO content production to supply a large number of participating agents to produce a large quantity of content items. FIG. 3 illustrates the production of one content item 363 by one of the many participating agent 356.

Upon enrolling 212 agent 356 to join the campaign, system central server 154 updates 314 client application 377 on computer 372 which is associated with agent 356.

Content item 363 is a talkback to be posted on a third party website 365 (a newspaper talkback page) which is not in the control of customer 352. Therefore, customer 352 requires 222 (see FIG. 2) further verification before content item 363 is submitted 226. Particularly, after verifying 219a that content item 363 fulfills the requirements of the campaign, content item 363 is sent 224 via client application 377 to central server 154, which redirects 324 the content item 363 to a queue of items waiting verification from customer 352. Server 154 notifies customer 352 that a post is waiting for his review. Customer 352 or a trusted employee logs onto server 154 and views content item 363 and verifies 219b that final submission 226 fulfills the requirements of the campaign.

Alternatively, central server 154 may include sophisticated verification routines.

After verification, system server 154 creates a set of instructions including further updating 214b for client application 377, and notifies agent 356 of verification 219b. Final submission to website 365 will be handled automatically by client application 377 without involving agent 356. Alternatively, in some cases a target website will have protection from automated access (for example a password or a captcha). In such cases, agent 356 will be prompted by client application 377 to supply the necessary information during the process of submission 226.

In an alternative embodiment, after agent 356 agrees to terms and installs client application 377, and client application 377 works invisibly. For example, when agent 356 logs onto the system to check for assignments, client application 377 is automatically initiated. When agent 356 accepts an assignment, the submission page of target website 165 opens on his browser. Agent 356 writes and submits the item. When Agent 356 presses the submit button, client application 377 traps and reroutes the submission as necessary to take care of verifications and final submission invisibly. For example, the submission may be checked by client application 377 and then submitted to target website 165 locally. Alternatively, server 154 may reroute the submission to central server 154 for more sophisticated handling and wait for verification before submitting the item to target website 165.

When agent 356 logs into his account, he is given instructions for posting the verified content item. The client application may execute a macro, which may be encoded/decoded by central server 154 secret key or other identifying information such as an agent or customer ID. When agent 356 execute the macro client application 377 decodes the macro, executes it on computer 372 (submitting 226 content item 363), destroys the macro, and notifies 220c central server 154 that content item 363 is awaiting the approval on target site 365. Encoding and destroying the macro prevents tampering with the posts by the agent, the customer or any third party once their content has be 2191,b verified to fill campaign requirements.

In addition to the above, system server 154 may periodically send instructions to client application 377 to remove expired macros that have not been used after set amount of time.

Throughout the campaign, system server 154 maintains separation between the agents 156a,b,c and customer 152. Details about customer 152 are not made available to agents 156a,b,c and the agent database is not made available to the customer 152. In some cases, connection to website 165 is controlled by the client application, which does not make available the address of website 165 to agents 156a,b,c. This protects agents from dishonest employers, protects customers from malicious parties, and cuts the overhead of dealing with hundreds of agents individually.

Employment of agents may include multi-level employment. Particularly, one agent may recruit other agents. Then when funds are transferred 234 to the recruited agent the recruiting agent would also receive a bonus payment 235. Similarly when the recruited agent recruits a further grandchild agent, then when the grandchild agent completes a task, both the first recruiting agent and the second recruiting agent also receive a bonus. Multilevel employment makes it possible for agents to make very significant salaries and increases the size of the crowd of potential agents.

Agents are employed by the system over multiple campaigns. The system supplies agents with consistent work and supplies customers with quality oversight and various contractual agreements for protection (such as non-disclosure agreements). Those familiar with the art of crowd-sourcing will recognize that employing agents by a system over multiple campaigns solves many of the problems of previous art single campaign crowd-sourcing methodologies. Multi-campaign participants earn reasonable salaries and agents are accountable for quality over the long term. Furthermore, a customer who wishes to save himself effort of checking and rejecting unsuitable submissions can specify that he wants only agents with reliable track records.

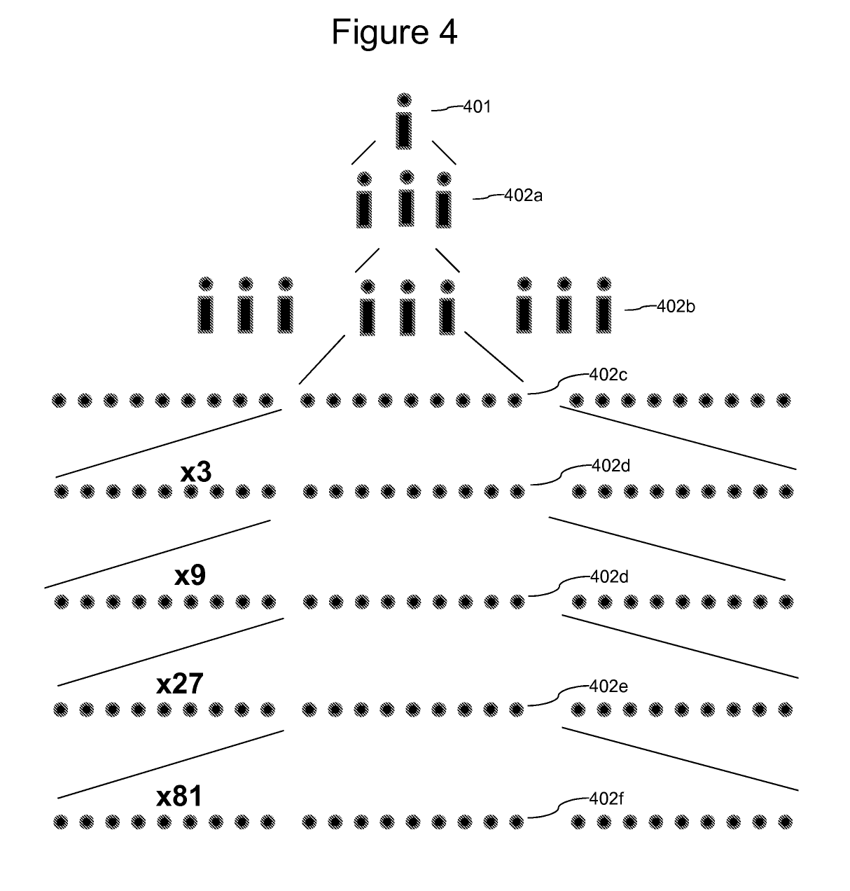

FIG. 4 illustrates multilevel employment. A recruiting agent 401 recruits 3 agents in a first offspring generation 402a. Each recruited agent recruits three agents in a second offspring generation 402b of nine agents. Each recruited agent recruits 3 agents in a third offspring generation 402c of twenty seven agents. Each recruited agent recruits 3 agents in a fourth offspring generation 402d of eighty one agents. Each recruited agent recruits 3 agents in a fifth offspring generation 402e of 243 agents. Each recruited agent recruits 3 agents in a sixth offspring generation 402e of 729 agents.

Recruiting agent 401 receives a passive income of 5% of all money earned by the first six generations of offspring agents and an additional bonus 5% passive income from all sixth generation offspring. The additional bonus is only available in a month when recruiting agent 401 earns at least $20 from his own writing. Thus, recruiting agent 401a gets paid for his own work and 5% for each of his offspring plus 10% for sixth generation offspring as long he himself continues writing at least $20 a month of material.

According to the above, if in a given month each offspring agent earns $10 then recruiting agent receives from first generation offspring 402a $10×3×5%=$1.50 plus $10×9×5%=$4.50 from second generation offspring 402b plus $10×27×5%=$13.50 from third generation offspring 402c plus $10×81×5%=$40.50 from forth generation offspring 402d plus $10×243×5%=$121.50 from fifth generation offspring 402e plus $10×729×5%=$364.50 from sixth generation 402f plus a bonus of $10×729×5%=$364.50 from sixth generation offspring 402f. Thus recruiting agent 401 receives a passive income of $20+$1.50+$4.50+$13.50+$40.50+121.50+$364.50+$364.50=$930.5 in a single month with few hours of work. Thus, the multilevel employment-recruiting scheme gives an agent the possibility of earning a full income.

Various alternative embodiments of multilevel employment are possible. For example, passive income may be unlimited. Thus, each generation could be arbitrarily big or small. Alternatively, each generation could be limited as three offspring to each parent. Then further offspring would be assigned to a productive agent in the next generation (this would give “free” offspring to offspring of a father who brings in a lot of agents). Parent agents may also have some responsibility for training their offspring or answering questions. Thus, good writers who do not have good recruiting skills may also get passive income. In addition, there may be requirements for passive income. For example, a parent agent may only be eligible for passive income if he produces at least $10 of content a month and he may be eligible for bonuses only when he produces $20/month. Thus, agents are encouraged to be productive and earn a good income.

Although production of content via crowd-sourcing has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for dispatching content production comprising:
a) initiating an invitation for the production of the content to a crowd of potential agents;
b) updating a respective client application for each agent of a plurality of participating agents from said crowd of potential agents, said updating said respective client application for submitting a respective content item authored by each agent from a respective personal computing device associated said each agent to a target site, and
c) facilitating verification of a compliance of said respective content item to a campaign profile prior to said submitting.

2. The method of claim 1, wherein said updating is further for notifying a central server of a status of said respective content item.

3. The method of claim 2, wherein said notifying includes notification of at least one condition selected from the group consisting of completion of said respective content item by said each agent, submission of said respective content item to said target site, reception of approval notification from said target site, unauthorized communication by said each agent with said target site, and inactivity of said respective personal computing device.

4. The method of claim 1, wherein said facilitating includes at least one action selected from the group consisting of a local grammar check, a local keyword check, a local check for undesirable matter, sending said respective content item to said server for said verification, sending said respective content item to an unaffiliated third party for said verification, rerouting a submission to said target site, trapping a submission to said target site and sending said respective content item to a customer for said verification.

5. The method of claim 1, further comprising:
d) reimbursing said each agent.

6. The method of claim 5, wherein said reimbursing is dependent upon at least one occurrence selected from the group comprising said submission of said respective content item to said target site, said verification of said respective content item, and a posting of said respective content item by said target site.

7. The method of claim 5, wherein said reimbursing further includes reimbursing a recruiting agent from said crowd of potential agents, when said recruiting agent recruited said each agent.

8. The method of claim 1, further comprising:
d) receiving an order from a customer for said content;
e) maintaining anonymity of said each agent from said customer, and
f) preserving anonymity of said customer from said each agent.

9. The method of claim 8, wherein said target site includes at least one attribute selected from the group consisting of being associated with said customer, being independent of said customer, being a blog, social network, forum, portal, being independent of said server and being a talkback list.

10. A system for production of content comprising:
a) a server configured for initiating an invitation to produce the content to a crowd of potential agents, and
b) a plurality of client applications, each application of said plurality of client applications configured for submitting to a target site a respective content item of said plurality of content items; said submitting from a personal computing device associated with said corresponding unique author.

11. The system of claim 10, wherein each of said plurality of client applications is further configured for notifying said server of a status of said respective content item.

12. The system of claim 11, wherein each of said plurality of client applications is further configured for notifying said server of a status of said respective content item dependent on at least one condition selected from the group consisting of completion of said respective content item by said corresponding unique author, submission of said respective content item to said target site, reception of an approval notification from said target site.

13. The system of claim 10, wherein each of said plurality of client applications is further configured for facilitating verification of compliance of said respective content item to a campaign profile prior to said submitting.

14. The system of claim 13, wherein each of said plurality of client applications is further configured for at least one action selected from the group comprising sending said respective content item to said server for said verification, sending said respective content item to an unaffiliated third party for said verification, and sending said respective content item to a customer for said verification.

15. The system of claim 10, wherein said server is further configured for:
iii) reimbursing an agent of said plurality of participating agents.

16. The system of claim 15, wherein said server is configured for performing said reimbursing dependent upon at least one occurrence selected from the group comprising said submitting, said verification, and posting of said respective content item by said target site.

17. The system of claim 15, wherein said server is further configured for reimbursing a recruiting potential agent from said crowd of potential agents, when said recruiting potential agent recruited said unique corresponding author.

18. The system of claim 10, wherein said server is further configured for:
iii) receiving an order from a customer for said content, and each of said plurality of client applications is further configured for maintaining anonymity of said corresponding unique author from said customer.

19. The system of claim 10, wherein each of said plurality of client applications is further configured for preserving anonymity of said customer from said corresponding unique author.

20. The system of claim 10, wherein said target site includes at least one attribute selected from the group consisting of being associated with said customer, being independent of said customer, being a blog, social network, forum, portal, being independent of said server and being a talkback posting system.
